(19) United States
(12) Patent Application Publication
(10) Pub. No.: US 2022/0194765 A1
(43) Pub. Date: Jun. 23, 2022

(54) SYSTEMS AND METHODS FOR USE IN COORDINATING BOOM MOTION OF A CONSTRUCTION MACHINE

(71) Applicant: Xtreme Manufacturing, LLC, Hendersonus, NV (US)

(72) Inventors: Jeffrey Lee Eckhardt, Las Vegas, NV (US); Stanley Walter Peterson, Henderson, NV (US)

(21) Appl. No.: 17/125,219

(22) Filed: Dec. 17, 2020

(51) Int. Cl. B66F 9/075; B66F 11/04; B66F 9/065; B66F 13/00

(52) U.S. Cl. CPC B66F 9/0755; B66F 13/00; B66F 9/0655; B66F 11/046

(57) ABSTRACT

A construction machine includes a boom and a control system. The control system is configured to receive at least a first motion command for repositioning the boom when the boom is deployed. In response to receiving the first motion command, the control system is also configured to reposition the boom in one of i) a substantially vertical path between a first position and a second position, or ii) a substantially horizontal path between the first position and the second position. As a result, the control system facilitates motion of the boom between the first position and the second position along a substantially linear, non-arcuate, path.

### FIELD

The field of the disclosure relates generally to construction equipment, and more particularly to systems and methods for use in coordinating the motion of a boom of a construction machine.

### BACKGROUND

A variety of known construction vehicles, such as boom lifts and cranes, may be used to move a payload between the ground and an elevated position, between ground-level positions, and/or between elevated positions. Such vehicles often include a telescoping boom, on the end of which may be connected an implement, such as a pair of forks or a work platform. Conventionally, such vehicles include a rear end, a front end, and a body extending therebetween, and the boom of such vehicles pivots about a horizontal axis located near the rear end of the vehicle. In some cases, the boom may also be configured to articulate at one or more pivot points or joints defined near a proximal end of the boom and/or a distal end of the boom.

During operation, at least some known construction vehicles may be selectively controlled by an operator at a control console. At least some known control consoles include a joystick or another control mechanism for use in selectively positioning the boom. More specifically, with known construction vehicles, as the boom is moved in any direction, other than being extended only vertically or only horizontally, the boom actually moves in an arc or with parabolic motion as it is being positioned. More specifically, although the intention of the operator may be to reposition the distal end of the boom in a given direction, the geometry of the boom itself (e.g., the combination of its length and relative pivot points) may cause the distal end of the boom to travel in an arc between its initial location and desired ending position. These shortcomings may be further exacerbated under certain environmental and other conditions, such as when the construction machine rests on a sloped or inclined travel surface, and/or depending upon a length of the boom and/or an angle of the boom relative to the travel surface.

Accordingly, it is desirable to use systems and methods that accurately coordinate the motion of a boom in a desired travel motion, i.e, such that a load is maintained in a desired orientation as the boom operated. More particularly, systems and methods that permit a coordinated motion of one or more physical parameters, such as a length of the boom and/or a spatial position of the boom, are desirable.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION

In one aspect, a construction machine including a boom and a control system is described. The control system is configured to receive at least a first motion command for repositioning the boom when the boom is deployed, and in response to receiving the first motion command, reposition the boom in one of i) a substantially vertical path between a first position and a second position, or ii) a substantially horizontal path between the first position and the second position.

In another aspect, a system for controlling a boom of a construction machine is described. The system includes a processor that is configured to receive, from an input device of the construction machine, an operator selection of one of i) a parabolic mode of operation, or ii) a rectilinear mode of operation. In response to receiving the operator selection of the rectilinear mode of operation, the processor is also configured to control the boom to reposition the boom from a first position to a second position, the second position different from the first position, along a substantially rectilinear path between the first position and the second position.

In yet another aspect, a system for controlling a boom of a construction machine is described. The system includes a processor that is configured to receive, from an input device of the construction machine, an operator selection of one of i) a parabolic mode of operation, or ii) a non-parabolic mode of operation. In response to receiving the operator selection of the non-parabolic mode of operation, the processor is also configured to control the boom to reposition the boom from a first position to a second position, the second position different from the first position in at least two degrees of motion within a Cartesian coordinate system.

### BRIEF DESCRIPTION OF THE DRAWINGS

FIG. 1A is a perspective view of a construction machine, such as an aerial work vehicle, in which a boom of the construction machine is lowered.

FIG. 1B is a perspective view of a construction machine, such as a telehandler having a material handling implement, in which a boom of the construction machine is lowered.

FIG. 2 is a perspective view of the construction machine shown in FIG. 1A, in which the boom of the construction machine is raised.

FIG. 3 is a block diagram of an exemplary control system that may be used with the construction machines shown in FIGS. 1A, 1B, and 2, to coordinate and control motion of the boom.

FIG. 4 is a side view of the construction machine shown in FIGS. 1A and 2, and illustrates an exemplary arcuate motion of the boom.

FIG. 5 is a side view of the construction machine shown in FIGS. 1A and 2, and illustrates an exemplary substantially linear motion of the boom during a coordinated motion of the boom, such as when a vertical or non-parabolic mode of operation is selected.

FIG. 6 is a side view of the construction machine shown in FIGS. 1A and 2, and illustrates an exemplary arcuate (e.g., circular) motion of the boom

FIG. 7 is a side view of the construction machine shown in FIGS. 1A and 2, and illustrates an exemplary a substantially linear motion of the boom during a coordinated motion of the boom, such as when a horizontal or non-parabolic mode of operation is selected.

FIG. 8 is a flowchart illustrating an exemplary process for coordinating motion of the boom of the construction machine shown in FIGS. 1A-7.

### DETAILED DESCRIPTION

A construction machine, also known as an aerial work vehicle or a telehandler, for example, and a system and method for controlling operation of the construction machine are described herein. In some implementations, the construction machine includes a chassis, which may be self-propelled, and a telescoping boom capable of being selectively extended and/or retracted relative to the chassis. The boom may also be configured to articulate at one or more pivot points, although in some embodiments, the boom is non-articulating. The boom may also include a jib, which may be mechanically coupled to a distal end of the boom and that may be pivotable or articulable relative to the distal end of the boom.

In the exemplary embodiment, the control system includes a processor and a memory device that stores instructions for execution by the processor. When the processor executes instructions stored on the memory device, a variety of operations may be performed, such as, for example, a position of the boom (including the jib) may be determined, motion commands from an operator of the boom may be received, and/or the motion of the boom relative to one or more axes and/or in one or more degrees of motion may be selectively coordinated to reposition the boom according to the motion command, and in such a manner that the boom does not travel along an arcuate path between its starting and ending positions, but rather travels along a substantially straight line path (e.g., vertical or horizontal), such as within an X-Y coordinate system, between the starting and stopping positions.

As a result, control of the boom (or a jib) may be greatly simplified, and may be performed in intuitive manner by an operator. As described herein, at least one technical problem encountered by many conventional boom lifts is that a motion command provided by an operator may result in the boom and/or, for example, a material handling implement coupled to the end of the boom or jib, traveling in an arcuate path. As a result of the arcuate travel path, although an operator may, for example, only intend to reposition the boom relative to a single axis of motion (e.g., vertically or horizontally), the ending position of the boom may in fact differ from the starting position in more than one dimension. These and other problems can, in addition, be exacerbated under a variety of conditions, such as, but not limited to the angle of the boom relative to the chassis, and/or the relative angle of the surface supporting the construction machine.

To remedy these and other shortcomings of known construction machines, the systems and methods described herein facilitate coordinated motion of one or more physical parameters of the boom, such as a length of the boom and/or a relative position of the boom, in a manner that enables movement along a path in an X-Y coordinate system rather than along an arcuate travel path. More particularly, the systems and methods described herein facilitate motion of the boom in real-time, and substantially simultaneously, in one or more degrees of motion to maintain and/or establish an ending position that is not offset from an intended position as a result.

Technical effects and improvements thus include, but are not limited to the following: (1) providing a construction machine, such as an aerial work vehicle (e.g., a telehandler, a crane, or a construction boom) capable of coordinating motion of a boom thereof in real-time and in at least two degrees of motion substantially simultaneously; (2) coordinating the motion of the boom in at least two degrees of motion to facilitate a substantially linear and/or rectilinear travel path between a starting position and an ending position in response to a motion command received from an operator of the construction machine; (3) coordinating the motion of the boom in at least two degrees of motion to reduce or eliminate an arcuate travel path of the boom during control of the boom by the operator; (4) sensing a variety of position information associated with the construction machine to determine, for example, an extension position of the boom, a chassis angle position of the construction machine, and a boom angle position relative to a reference surface; (5) coordinating the motion of the boom in at least two degrees of motion in conjunction with the sensed position information to further simply control of the boom and facilitate travel of the boom along a substantially linear and/or rectilinear travel path; and (6) coordinating the motion of the boom in an X-Y coordinate system to facilitate travel in a linear and/or rectilinear (e.g., non-arcuate) travel path.

In the following specification and the claims, reference will be made to a number of terms, which may be used in conjunction with the following meanings.

The singular forms “a”, “an”, and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Moreover, as used herein, the terms “vertical” and “horizontal” may generally refer to directions substantially parallel to a line of gravity of an object and substantially normal to a line of gravity of an object, respectively. For example, a vertical travel path and/or vertical motion may refer to a travel path and/or direction that are substantially parallel to a line of gravity, as defined by, and extending through, a center of gravity of an object, such as construction machine 100. Likewise, as used herein, a horizontal travel path and/or horizontal motion, for example, may refer to a travel path and/or direction that is substantially normal or orthogonal to the line of gravity and/or vertical travel path. In other uses, the terms “vertical” and “horizontal” may refer more generally to non-parabolic or non-arcuate directions of travel within an X-Y coordinate system, for example.

Likewise, as used herein, spatially relative terms, such as “beneath,” “below,” “under,” “lower,” “higher,” “above,” “over,” and the like, may be used to describe one element or feature's relationship to one or more other elements or features as illustrated in the figures. It will be understood that such spatially relative terms are intended to encompass different orientations of the elements and features described herein both in operation as well as in addition to the orientations depicted in the figures. For example, if an element or feature in the figures is turned over, elements described as being “below” one or more other elements or features may be regarded as being “above” those elements or features. Thus, exemplary terms such as “below,” “under,” or “beneath” may encompass both an orientation of above and below, depending, for example, upon a relative orientation between such elements or features and one or more other elements or features.

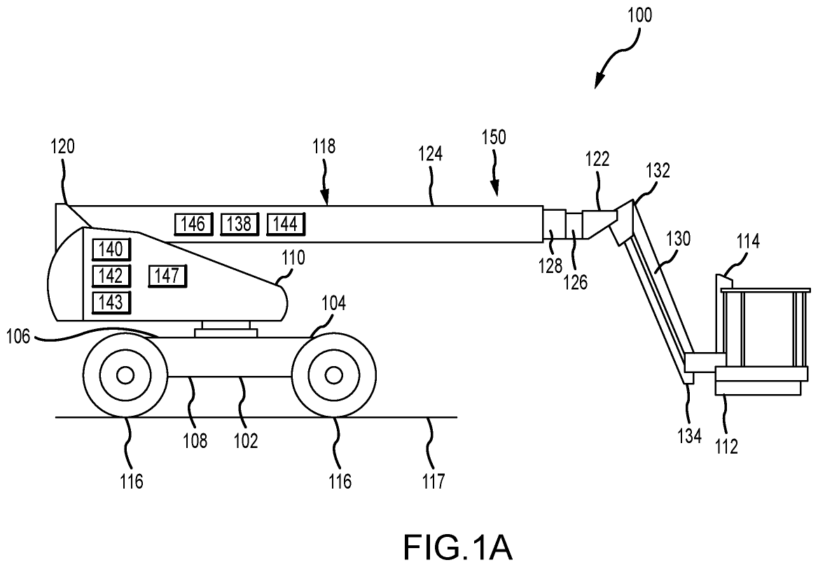

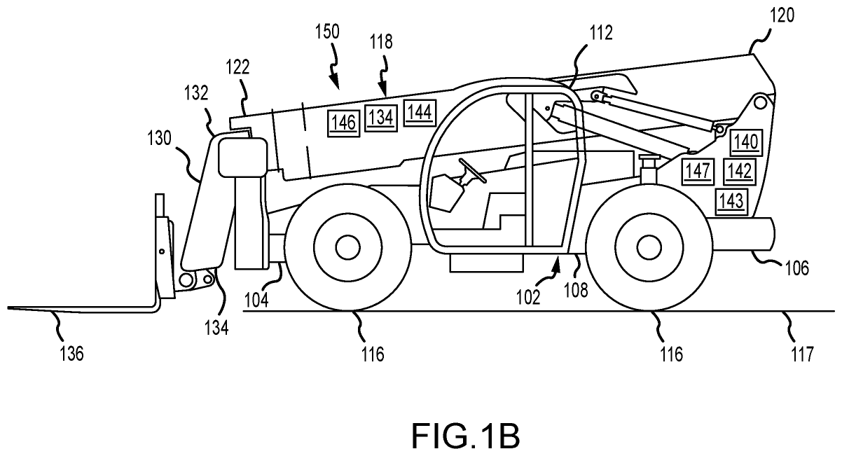

FIG. 1A is a perspective view of an exemplary construction machine 100, such as any of a variety of aerial work vehicles (AWVs), including, but not limited to, construction machines, such as boom lifts, construction cranes, telehandlers, and the like. FIG. 1B is a perspective view of construction machine 101, such as a telehandler, having one or more forks. In FIG. 1B, construction machine 101 is similar to construction machine 100 shown in FIG. 1A, except, for example, that in FIG. 1B, construction machine 101 includes a material handling implement 136 having one or more forks, rather than a work platform 112. In FIGS. 1A and 1B, construction machines 100 and 101 are in a lowered position. Although the systems and processes are described herein in relation to the construction machine 100 shown in FIG. 1A, it will be appreciated that the same description applies to the telehandler 101 shown in FIG. 1B.

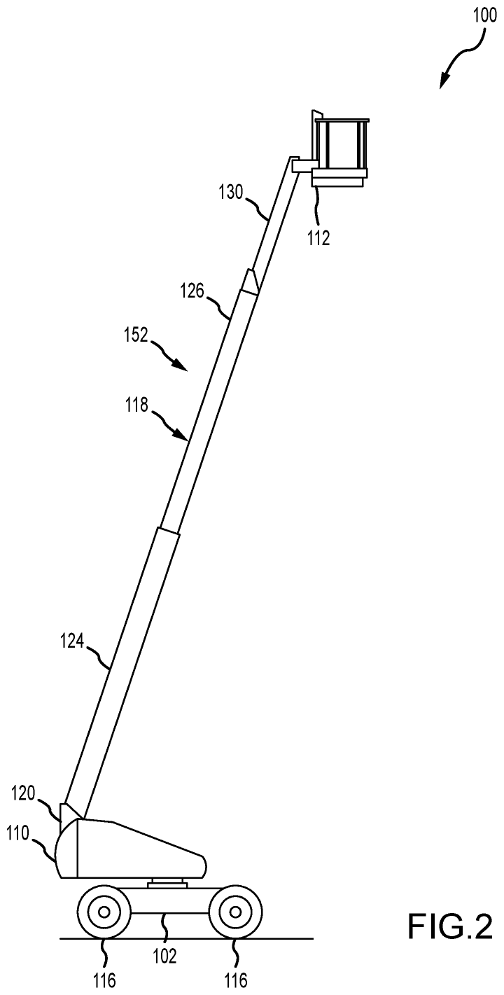

FIG. 2 generally shows construction machine 100 in an extended and raised position. It will be appreciated that the systems and methods described herein may be used in association with any of a variety of other machines, including any construction machine that includes a boom, such as telehandler 101 shown in FIG. 1B as well as more generally in association with any other type of AWV, such as construction machine 100 shown in FIG. 1A.

Accordingly, with general reference to FIGS. 1A and 2, in the exemplary embodiment, construction machine 100 includes a chassis 102 having a forward end 104, an aft end 106 that is opposite forward end 104, and a body 108 extending therebetween. In the exemplary embodiment, a rotary table 110 is rotatably coupled to chassis 102. In addition, in many implementations, construction machine 100 includes an operator cab or platform 112 including at least one input device 114, such as at least one control panel, at least one joystick, and the like. In at least some embodiments, construction machine 100 may also include an additional operator cab (not shown) on or near chassis 102, which may also include a input device, such as a joystick and/or control panel (not shown). In some embodiments, input device 114 may not be on platform 112, but rather may be located near chassis 102. In some embodiments, rotary table 110 can be selectively controlled by an operator using input device 114 and is capable of 360° motion.

In some embodiments, construction machine 100 may also include a plurality of wheels 116, such as powered drive wheels, that may each be powered by individual propulsion motors to enable a variety of travel operations to be performed unique to machines of this type, such as motion involving unique angles, crabbing, and/or other precise motion control adjustments. Wheels 116 generally contact a reference surface 117, such as the ground.

In the exemplary embodiment, construction machine 100 also includes a boom 118 that pivotally extends from chassis 102. In various embodiments, boom 118 may be non-articulating (e.g., a “beam boom”) or may be an articulated boom that includes at least one pivot joint (not shown) and that is capable of articulating motion. In addition, in the exemplary embodiment, boom 118 includes a proximal end 120 and a distal end 122, and boom 118 is pivotally coupled to rotary table 110 of chassis 102 at or near proximal end 120. Further in some embodiments (e.g., if rotary table 110 is excluded), boom 118 may be pivotably coupled to another portion of chassis 102.

In the exemplary embodiment, boom 118 is a telescoping boom that includes at least a first boom section 124 and second boom section 126 coupled together at a slidable joint 128. Moreover, in the exemplary embodiment, a high pressure fluid system (not shown) provides a motive force for operating boom 118. It will be appreciated that the high pressure fluid system may use an oil, such as any of a variety of hydraulic oils, and/or another high pressure hydraulic fluid for controlling motion operations of boom 118 (e.g., raising, lowering, extending, etc).

In the exemplary embodiment, boom 118 also includes a jib 130. Jib 130 includes a proximal end 132 and a distal end 134. In the exemplary embodiment, proximal end 132 of jib 130 is pivotally coupled to distal end 122 of boom 118. Jib 130, in the exemplary embodiment, also includes work platform 112 (as shown). Alternatively, jib 130 may include material handling implement 136 (e.g., one or more forks) that extends from distal end 134 thereof. As described herein, a construction machine 101, such as a telehandler, that includes an implement 136 having one or more forks is shown in FIG. 1B. Jib 130 permits boom 118 to extend over, for example, obstacles, such as walls and/or heating and ventilating equipment on a roof.

In the exemplary embodiment, construction machine 100 also includes one or more sensor devices 137 each of which may be positioned on and/or within construction machine 100 to measure or determine information about a position or orientation of construction machine 100. For example, construction machine may include a first sensor device 138, such as a linear sensor, that may be used to determine a boom extension position.

As used herein, determining a boom extension position may include determining a length of boom 118 and/or other information about an extension position of boom 118, which may, as described above, be capable of telescoping between a range of extension positions or lengths. For instance, in FIG. 1A, boom 118 is shown in a first, non-extended position 150, and FIG. 2 shows boom 118 in a fully-extended or fully-telescoped extension position 152. However, it should be noted that boom 118 may telescope to any extension position, or length, along a substantially continuous range between the non-extended and fully-extended extension positions 150 and 152, respectively. In some embodiments, a plurality of linear sensor devices 138 can be used to determine a boom extension position.

Construction machine 100 may include a second sensor device 140, such as an angle sensor, which may be used to determine a boom angle position and/or an elevation of boom 118. In some implementations, second sensor device 140 may be used to determine an angle of boom 118 relative to reference surface 117. Likewise, in at least some implementations, second sensor device 140 may determine a boom angle position of boom 118 relative to a reference plane and/or relative to a portion of construction machine 100, such as chassis 102 and/or rotary table 110. Accordingly, as used herein, determining a boom angle position may include determining an angle of boom 118 relative to a reference plane, such as reference surface 117 and/or relative to another portion of construction machine 100, including, but not limited to chassis 102 and/or rotary table 110. Likewise, determining a boom angle position may include determining a boom elevation and/or using a processor 302, as described herein, to determine an elevation of boom 118 based on a plurality of sensor data, including, but not limited to, boom length, and/or boom angle position data. In some embodiments, a plurality of angle sensor devices 140 may be coupled within machine 100.

Construction machine 100 may also include at least a third designated sensor device 142, such as a tilt sensor, which may be used to determine a relative chassis angle position of construction machine 100. As used herein, determining a chassis angle position may include determining an inclination or angle of a portion of construction machine 100, such as chassis 102, relative to reference surface 107 and/or relative to another suitable reference plane. Third sensor device 142 may therefore measure or determine an inclination or angle of chassis 102, or another portion of construction machine 100, relative to reference surface 107. In some embodiments, a plurality of tilt sensor devices 142 may be incorporated in machine 100.

Additionally, in at least some embodiments, construction machine 100 may include at least a fourth sensor device 143 that is used to determine or measure a relative position of rotary table 110. The position of rotary table 110 may indicate a relative orientation of boom 118 within a 360° range of motion permitted by rotary table 110. Further, in at least some embodiments (e.g., if rotary table 110 is not present), fourth sensor device 143 may determine a relative orientation of boom 118 within a 360° range of motion permitted by, for example, another rotary mechanism and/or based upon a position of boom 118 in a range of motion that can be achieved by repositioning wheels 116 in a given orientation to position chassis 102 and/or construction machine 101 and/or 101.

In the exemplary embodiment, construction machine 100 also includes one or more actuators, such as, for example, at least a first actuator 144 and a second actuator 146. In the exemplary embodiment, actuators 144 and 146 are hydraulic actuators, such as solenoid valves. Mechanical details of actuators 144 and 146 are not central to an understanding of the present disclosure. However, it will be appreciated that actuators 144 and 146 can be used to adjust a flow rate of hydraulic fluid, as described herein, in a high pressure hydraulic flow system of construction machine 100. As a result, actuators 144 and 146 can be selectively actuated to facilitate controlling a position and/or motion of boom 118.

For example, in at least some embodiments, first actuator 144 may be operated to control vertical movement of boom 118. In at least some embodiments, first actuator 144 may be referred to as an “extend valve,” which may be operated at a pre-determined flow rate (as described herein and further below) to selectively extend and retract (i.e., control telescoping) of boom 118. Likewise, second actuator 146 may be operated to selectively control an angle position or elevation of boom 118. In at least some embodiments, second actuator 146 may be referred to as a “lower/lift valve.”

Further, in at least some embodiments, first actuator 144 may additionally or alternatively control a motion of boom 118 by extending or retracting jib 130 relative to main boom sections 124 and 126. In at least some implementations, a plurality of first actuators are provided to enable selective extension or retraction of boom sections 124 and 126, and/or jib 130.

Likewise, in at least some implementations, second actuator 146 may additionally or alternatively control motion of boom 118 by selectively elevating or lowering jib 130 relative to main boom sections 124 and 126. In at least some implementations, a plurality of second actuators are provided to enable selective elevating or lowering of boom sections 124 and 126 as well as jib 130.

In addition to actuators 144 and 146, in at least some embodiments, control system 300 may also include a third actuator 147, which may selectively engage or control rotation of rotary table 110 within a 360° range of motion, depending upon a motion command provided by an operator.

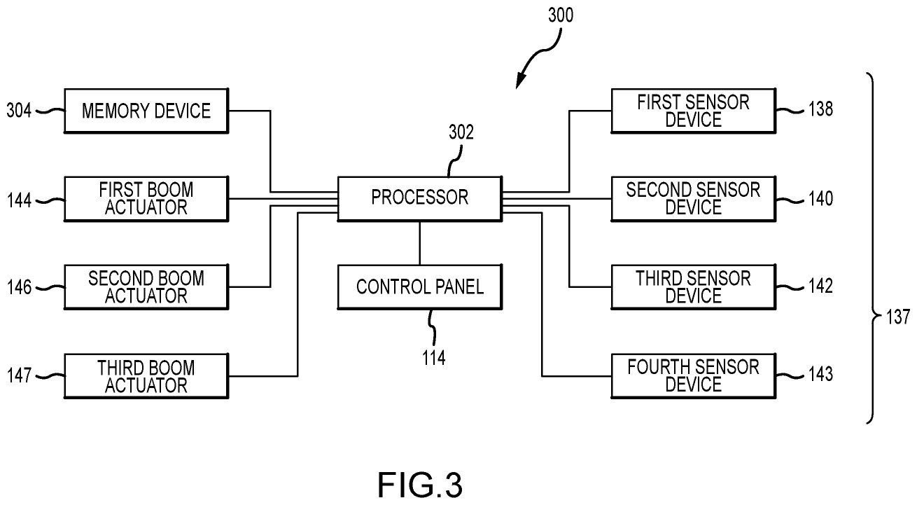

FIG. 3 is a block diagram of an exemplary control system 300 that may be used with construction machine 100 and/or construction machine 101, as described above, and which may be used to selectively coordinate and control motion of boom 118 during operation of construction machine 100 and/or 101. Specifically, in the exemplary embodiment, control system 300 can be used to selectively coordinate a motion of boom 118 in one or more degrees of motion and/or in response to one or more commands received from input device 114 to reposition boom 118, based on the motion command, in a substantially vertical and/or substantially horizontal travel path (e.g., along a substantially linear path defined between a starting position and an ending position). Further, in at least some embodiments, control system 300 may coordinate motion of boom 118 in several degrees of motion in real-time (e.g., as an operator provides motion commands) and/or substantially simultaneously. In other embodiments, control system 300 may selectively adjust a position of boom 118 in a first degree of freedom followed, subsequently, by one or more adjustments in one or more other degrees of freedom.

As such, in the exemplary embodiment, control system 300 includes a processor 302 communicatively coupled to a memory device 304 that stores instructions which when executed by processor 302 are configured to cause processor 302 to perform the control processes and actions described herein. In some embodiments, memory device 304 may be physically separate from processor 302. Alternatively or additionally, memory device 304 may be included on processor 304, such as, for example, as part of an integrated circuit of processor 304.

In at least some embodiments, memory device 304 may include one or more devices that enable information, such as executable instructions and/or other data, to be stored and retrieved. Moreover, the memory device 304 may include one or more computer readable media, such as, without limitation, dynamic random access memory (DRAM), static random access memory (SRAM), a solid state disk, and/or a hard disk. As described herein, in the exemplary embodiment, memory device 304 may store, without limitation, application source code, application object code, configuration data, additional input events, application states, assertion statements, validation results, and/or any other type of data. Control system 300 may, in some embodiments, also include a communication interface that is coupled to the processor 302 via a system bus, which may also interconnect memory device 304, any of a variety of peripheral devices, such as sensors and/or actuators, and the like.

Accordingly, and as shown, processor 302 may be communicatively coupled to first sensor device 138 (linear sensor device), second sensor device 140 (angle sensor device), third sensor device 142 (tilt sensor device), fourth sensor device 143 (rotary table position sensor), input device 114, first boom actuator 144 (extend valve), second boom actuator 146 (lower/lift valve), and/or third actuator 147 (rotary table actuator).

Control system 300 may thus function, in at least some embodiments, to coordinate and control motion of boom 118 along a substantially linear and/or rectilinear travel path of boom 118 (e.g., of implement 136, jib 130, and/or distal end 122 of boom 118) as defined between a starting position and an ending position of boom 118. For example, in some circumstances, an operator of construction machine 100 may provide one or more motion commands to input device 114 (e.g., using a joystick) to selectively move boom 118 in a substantially vertical motion. Likewise, in some circumstances, the operator may provide motion commands via input device 114 to move boom 118 horizontally.

In at least some implementations, vertical motion control and horizontal motion control may be selectively provided via a vertical motion control mode and a horizontal motion control mode, respectively, both of which the operator of construction machine 100 may selectively specify via input device 114. In addition, as described herein, the horizontal and/or vertical motion control modes may be included in a non-parabolic mode of operation, which may function to select either or both of the horizontal and vertical modes. For example, input device 114 may include, in addition to a joystick (not shown) for controlling boom 118, the ability to select a first vertical mode option and/or a second horizontal mode option (e.g., via a button or software interface). The operator may select the vertical mode option prior to using the joystick to move boom 118 vertically, and/or the horizontal mode option prior to using the joystick to move boom 118 horizontally.

In at least some embodiments (e.g., a general non-parabolic mode), these modes may not be segregated, and the operator may provide both vertical and/or horizontal motion commands via input device 114 in any sequence or combination (e.g., the operator may provide a horizontal and a vertical motion command together or one after another, sequentially and/or continuously, without switching control modes). In other embodiments, the operator may select a mode of operation prior to moving boom 118 in accordance with the selected mode.

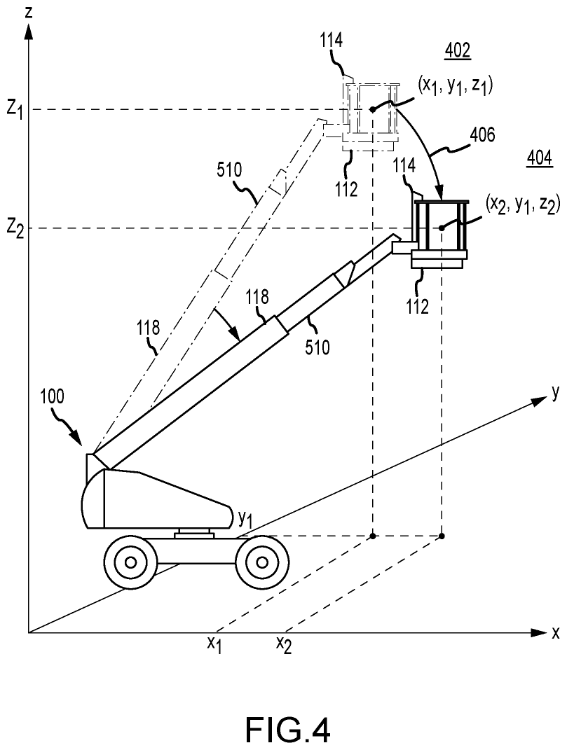

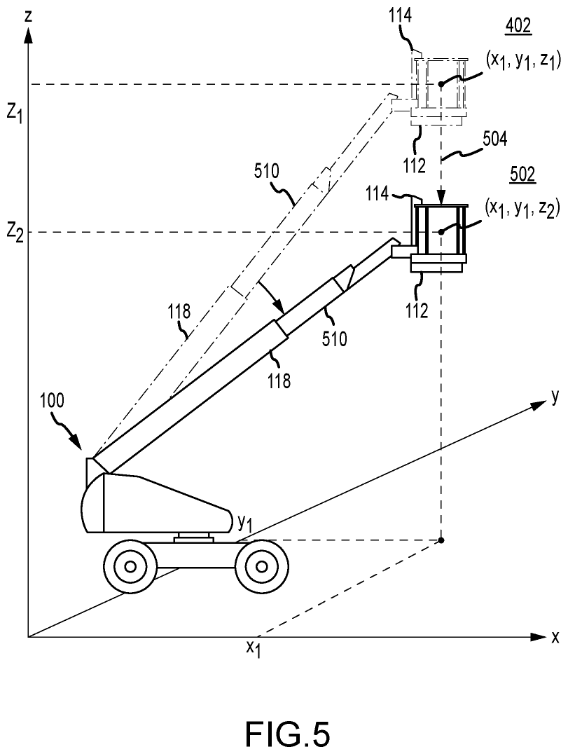

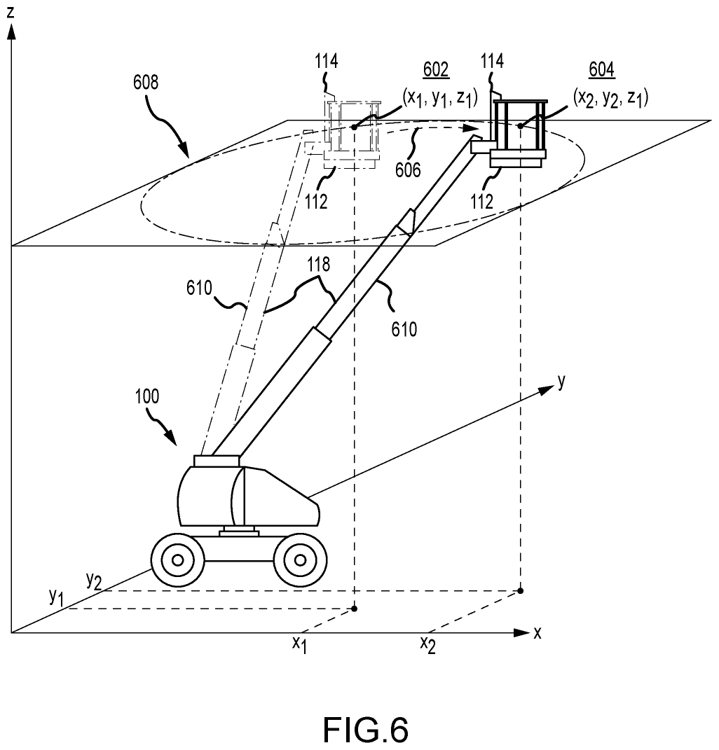

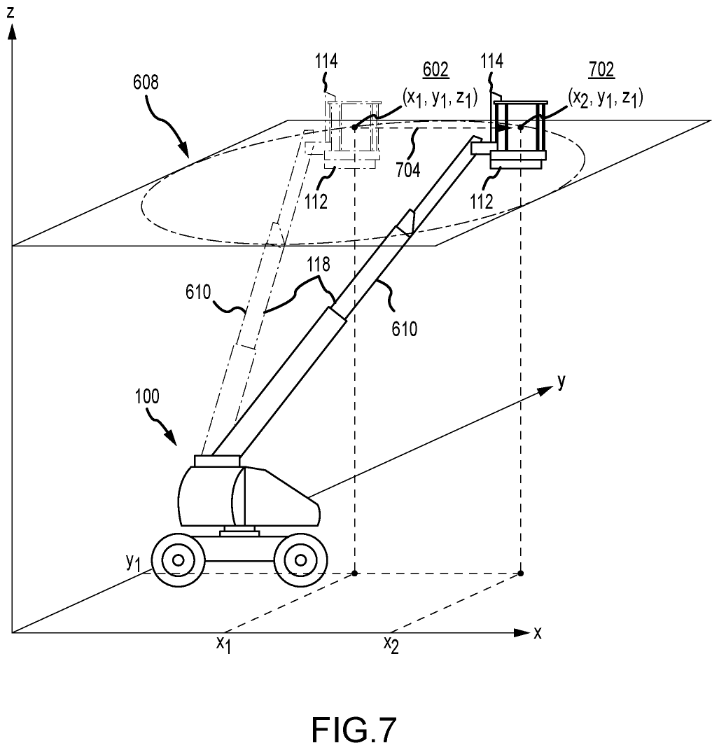

In addition, in at least some embodiments, a parabolic mode of motion control may be provided in addition to a non-parabolic (e.g., horizontal or vertical) mode of motion control. During use, in the parabolic mode of operation, boom 118 may be repositioned, as described herein, along an arcuate path (e.g., as shown in FIGS. 4 and 6) defined between a first position (e.g., a starting position) and a second position. Conversely, in the non-parabolic mode of operation, which may be the same as either or both of the horizontal or vertical modes of operation and/or an alternative to or additional to these modes, boom 118 may be selectively repositioned, as described herein, along a substantially linear path between the first position and the second position (e.g., as shown in FIGS. 5 and 7). Thus, an operator may select a variety of control modes, including vertical, horizontal, non-parabolic, and/or parabolic.

FIG. 4 is a side view of construction machine 100 and illustrates an arcuate motion of boom 118, such as when a vertical mode of operation is not selected (e.g., as described above) and/or in the instance that control system 300 is not used, as described herein, to coordinate a vertical motion of boom 118 along a substantially linear travel path (e.g., when a parabolic mode is selected). FIG. 5, in contrast, is a side view of construction machine 100 and illustrates a substantially linear motion of boom 118, such as when the vertical or non-parabolic mode of operation is selected and implemented by control system 300. As described herein, although FIG. 4 and FIG. 5 are described with reference to construction machine 100, it will be appreciated that the systems and processes described in reference to these figures may also, in at least some embodiments, be applied to telehandler 101.

Accordingly, with initial reference to FIG. 4, and as shown, in the absence of coordinated boom motion, boom 118 may be repositioned, in response to a vertical motion command (e.g., motion of a joystick of input device 114 in an up-and-down motion), from a first position 402 to a second position 404 along a non-linear, or arcuate, travel path 406. In the Cartesian coordinate system, first position 402 can be defined by a first X-coordinate (X1), a first Y-coordinate (Y1), and a first Z-coordinate (Z1), which can be expressed in Cartesian form as (X1, Y1, Z1). Likewise, second position 404 is defined by a second X-coordinate (X2), the first Y-coordinate (Y1), and a second Z-coordinate (Z2), which can together be expressed as (X2, Y1, Z2).

As a result, it can be seen that boom 118 follows travel path 406, which is arcuate, in response to a vertical motion command in the absence of coordinated boom motion. The arcuate shape of travel path 406 occurs, as will be appreciated, as a result of the length of boom 118, which remains substantially constant as boom 118 is repositioned from first position 402 to second position 404.

Referring to FIG. 5, in the exemplary embodiment, control system 300 (e.g., processor 302) can operate to reposition boom 118 along a substantially linear and/or rectilinear travel path, in such a manner that facilitates preventing or reducing arcuate travel of boom 118 as described above. This control system travel mode may be variably selected, in at least some embodiments, to simplify motion control of boom 118 during operation, such that an operator of construction machine 100 can easily reposition boom 118 vertically without having to correct for unwanted travel displacement along arcuate path 406.

Rather, processor 302 may, in the exemplary embodiment, adjust a length 510 of boom 118 in real-time and as boom 118 is repositioned. Specifically, processor 302 can adjust a length 510 of boom 118 in response to the vertical motion command between first position 402 and a different second position 502 along a substantially linear travel path 504. As shown, second position 502 is vertically displaced from first position 402 and, in the example, is associated with the coordinates (X1, Y1, Z2). Stated another way, second position 502 has the same X-coordinate (X1) and Y-coordinate (Y1) as first position 402, where as a result, second position 502 differs from first position 402 only in the Z-direction.

To adjust the length 510 of boom 118 in real-time, processor 302 may, as described above, receive, from one or more sensor devices 138-143, sensor data, indicative of an extension position of boom 118, an angle position or elevation of boom 118, a tilt angle of chassis 102, and/or a position of rotary table 110. In some embodiments, processor 302 determines first position 402 of boom 118, which is associated with coordinates (X1, Y1, Z1). For example, first position 402 may be determined by processor based upon the received sensor data, such as based upon a position of rotary table 110, boom length, and boom angle.

Processor 302 may also receive a first motion command from input device 114, such as a vertical motion command. In response to receiving the sensor data and motion command, processor 302 may determine second position 502 is vertically offset from first position 402, where as described above, second position 502 is associated with coordinates (X1, Y1, Z2). In response to determining second position 502, processor 302 may coordinate motion of boom 118 by lowering boom 118 vertically (or raising boom 118 vertically) as well as retracting (or extending) boom 118 to arrive at second position 502.

As a result, an angle (or elevation) of boom 118 may be adjusted by processor 302 in real-time and in conjunction with length 510 of boom 118 to coordinate motion of boom 118 (e.g., distal end 134 of boom 118 and/or implement 136) vertically along a linear path between first position 402 and second position 502. To change length 510 of boom 118, as described above, processor 302 can control an appropriate boom actuator 144-146 to retract or extend one or more main boom sections 124-126 (e.g., by telescoping boom 118).

Further, in at least some embodiments, processor 302 may control one or more actuators 144-147 to selectively control an angle and/or elevation of jib 130. Control of jib 130 may be performed in combination with extending or retracting main boom sections 124-126 and/or without telescoping main boom sections 124-126. As a result, it can be seen that there are several ways to adjust length 510 of boom 118—e.g., by telescoping boom 118 and/or by adjusting a position of jib 130.

In at least some embodiments, processor 302 may not perform one or both of the X- and Y-coordinate determination, as described above, for vertical motion commands. Rather, processor 302 may simplify the vertical motion operation by only determining a second Z-position (e.g., Z2) in the example above and raising or lowering boom in coordination with extending or retracting boom 118 (and/or jib 130) to arrive at the second Z-position (Z2). This can be achieved, because in a vertical motion command, the X- and Y-coordinates may be held constant. Further, in at least some embodiments, processor 302 may not determine coordinates as described but rather simply adjust boom angle position or elevation in coordination with boom length to ensure vertical motion of boom 118.

Accordingly, motion of boom 118 may be coordinated by processor 302 in real-time or substantially real-time in one or more degrees of motion. For example, as described above, processor 302 can control vertical motion of boom 118 in a first degree of motion relative to the Z-axis by raising and/or lowering boom 118. Likewise, processor 302 can control a vertical motion of boom 118 by extending or retracting boom 118, as described above, in second degree of motion. Further, as described in additional detail below, processor 302 may also control a horizontal motion of boom 118 in a third degree of motion by causing rotary table 110 to rotate and/or by pivoting boom 118 and/or jib 130 in a horizontal or substantially horizontal direction.

In the vertical mode of motion control, processor 302 may thus reposition boom 118 in at least a first degree of motion (e.g., by raising and/or lowering boom relative to reference surface 107) and/or in a second degree of motion (e.g., by extending or retracting boom 118 and/or by raising, lowering, extending, or retracting jib 130). Likewise, in the vertical mode of motion control, processor 302 may, in at least some cases, hold a third degree of motion (e.g., the horizontal degree of motion) constant or relatively constant, to reposition boom, as described above, between coordinates having the same or almost the same X- and Y-components (e.g., between (X1, Y1, Z1) and (X1, Y1, Z2).

In addition to the coordinated motion control features described above, in some implementations, a tilt angle of construction machine, such as a tilt angle of chassis 102, may be measured or otherwise determined by third sensor device 112 and used, in association with one or more other parameters, such as boom angle position, boom length, and one or more starting coordinates (e.g., first position 402), to further selectively control a position of boom 118. For example, in some circumstances, construction machine 100 may be positioned on a sloping surface, such as a hillslope. In response to a motion control command, processor 302 may determine the X- Y- and/or Z-components of second position 502 based on the chassis angle position to account for the tilt angle of chassis 102 as well.

In addition to the vertical motion control features described above, in the exemplary embodiment, processor 302 may also selectively control boom 118 in a horizontal motion control mode. As described herein, the horizontal motion control mode may be provided independently and/or in conjunction with the vertical motion control mode, such that, for example, in at least some embodiments, the operator of construction machine 100 may select either of the vertical or horizontal motion control modes and/or these modes may be engaged without requiring an operator to select a given mode.

Accordingly, FIG. 6 is a side view of construction machine 100 and shows an arcuate motion of boom 118, such as when a horizontal mode of operation is not selected (e.g., when a parabolic mode is selected and/or when a non-parabolic mode is not selected, as described above) and/or in the instance that control system 300 is not used to coordinate a horizontal motion of boom 118 along a substantially linear travel path. FIG. 7, in contrast, is a side view of construction machine 100 and shows a substantially linear motion of boom 118, such as when the horizontal (or non-parabolic) mode of operation is selected and implemented by control system 300. As described herein, although FIG. 6 and FIG. 7 are described with reference to construction machine 100, it will be appreciated that the systems and processes described in reference to these figures may also, in at least some embodiments, be applied to telehandler 101.

With initial reference to FIG. 6, and as shown, in the absence of coordinated boom motion, boom 118 may be selectively repositioned, in response to a horizontal motion command (e.g., motion of a joystick of input device 114 in an left-and-right motion), from a first position 602 to a second position 604 along a non-linear, or arcuate, travel path 606. In the Cartesian coordinate system, first position 602 is defined by a first X-coordinate (X1), a first Y-coordinate (Y1), and a first Z-coordinate (Z1), which can be expressed as in Cartesian form as (X1, Y1, Z1). Likewise, second position 604 is defined by a second X-coordinate (X2), a second Y-coordinate (Y2), and the first Z-coordinate (Z1), which can together be expressed as (X2, Y2, Z1).

As a result, it can be seen that boom 118 follows travel path 606, which is arcuate, in response to a horizontal motion command and in the absence of coordinated boom motion. The arcuate shape of travel path 606 occurs, it will be appreciated, as a result, in this example, of a length 610 of boom 118 and rotation of rotary table 110, which together cause boom 118 to trace an arcuate shape 608 (e.g., a circle) in the X-Y plane at a constant Z-value as boom 118 is repositioned from first position 602 to second position 604. In some embodiments (not shown), jib 130 may be pivotable about distal end 134 of boom 118, where as a result, jib 130 may also be pivoted to reposition boom 118 horizontally.

Referring to FIG. 7, in the exemplary embodiment, control system 300 (e.g., processor 302) can operate to reposition boom 118 along a linear or substantially linear travel path. This feature may be employed, in at least some embodiments, to simplify motion control of boom 118 during operation, such that an operator of construction machine 100 can easily reposition boom 118 horizontally without having to subsequently correct for unwanted arcuate boom motion.

Rather, processor 302 may, in at least some embodiments, adjust one or more position parameters, such as length 610 and/or elevation of boom 118, in real-time and as boom 118 is repositioned in response to the horizontal motion command. For instance, processor 302 may reposition boom 118 between first position 602 and a different second position 702 along a substantially linear travel path 704. As shown, second position 702 is horizontally displaced from first position 602 and, in this example, is associated with the coordinates (X2, Y1, Z1). Stated another way, second position 702 has the same Y-coordinate (Y1) and Z-coordinate (Z1) as first position 602, where as a result, second position 702 differs from first position 602 only in the X-direction.

To adjust the length and/or elevation of boom 118 in real-time, processor 302 may, as described above, receive, from one or more sensor devices 138-143, sensor data, which may indicate an extension position of boom 118, an angle position of boom 118, a tilt angle of chassis 102, and/or a position of rotary table 110, as described in additional detail above. In some embodiments, processor 302 determines first position 602 of boom 118, which is associated with coordinates (X1, Y1, Z1). However, in other embodiments, as described herein, processor 302 may omit determination of position 602. Rather, in at least some embodiments, processor 302 may simply adjust a position of rotary table 110, boom length 610, and/or a boom angle or elevation to ensure a substantially linear (horizontal) travel path.

Processor 302 may also receive a first motion command from input device 114, such as a horizontal motion command. In response to receiving the sensor data and motion command, processor 302 may determine second position 702 horizontally adjacent first position 602, where as described above, second position 702 is associated with coordinates (X2, Y1, and Z1). In response to determining second position 502, processor 302 may selectively coordinate motion of boom 118 by rotating rotary table 110, lowering boom 118 vertically (or raising boom 118 vertically) as well as retracting (or extending) boom 118. The coordinating motions applied to boom 118 by processor may vary depending upon the position and location of boom, the sensor data, and/or other parameters. However, it can be seen that processor 302 may adjust boom 118 in one or more degrees of motion, as described in additional detail below.

Therefore, and as a result, any of an angle (or elevation) of boom 118, length 610 of boom 118, and/or a position of rotary table 110 may be selectively adjusted by processor 302 in real-time to coordinate motion of boom 118 (e.g., distal end 134 of boom 118 and/or implement 136) horizontally along a linear path between first position 602 and second position 702. To change length 610 and/or elevation of boom 118, as described above, processor 302 can control an appropriate boom actuator 144-147.

Further, in at least some embodiments, processor 302 may control one or more actuators 144-147 to selectively control an angle and/or elevation of jib 130. Control of jib 130 may be performed in combination with extending or retracting main boom sections 124-126 and/or without telescoping main boom sections 124-126. As a result, it can be seen that there are several ways to adjust an elevation and/or length 610 of boom 118—e.g., by telescoping boom 118 and/or by adjusting a position of jib 130.

Accordingly, motion of boom 118 may be selectively coordinated by processor 302 in real-time or substantially real-time in one or more degrees of motion. For example, as described above, processor 302 can control vertical motion of boom 118 in a first degree of motion relative to the Z-axis by raising and/or lowering boom 118. Likewise, processor 302 can control a vertical motion of boom 118 by extending or retracting boom 118, as described above, in second degree of motion. Further, as described herein, processor 302 may also control a horizontal motion of boom 118 in a third degree of motion by causing rotary table 110 to rotate and/or by pivoting boom 118 and/or jib 130 in a horizontal or substantially horizontal direction.

In the horizontal mode of motion control, processor 302 may thus reposition boom 118 in at least a first degree of motion (e.g., by raising and/or lowering boom relative to reference surface 107). In addition, in the horizontal mode of motion control, processor 302 may reposition boom 118 in a second degree of motion (e.g., by extending or retracting boom 118 and/or by raising, lowering, extending, or retracting jib 130) and/or a third degree of motion by rotating rotary table 110 and, consequently, boom 118. As a result, boom 118 may be repositioned in a horizontal plane (e.g., between (X1, Y1, Z1) and (X2, Y1, Z1). Although in the example shown herein, boom 118 is repositioned in the X-direction, it will be appreciated that boom may also be horizontally repositioned in the Y-direction and/or in the X- and Y-directions simultaneously, such as by way of a rectilinear repositioning process in which boom 118 is repositioned in the X-direction and the Y-direction in sequence or series and/or substantially along a continuous travel path in an X-Y plane.

In addition, as described above, in some embodiments, a tilt angle of construction machine, such as a tilt angle of chassis 102, may be measured or otherwise determined by third sensor device 112 and used, in association with one or more other parameters, such as boom angle position, boom length 606, and one or more starting coordinates (e.g., first position 602), to further control a position of boom 118. For example, in some circumstances, construction machine 100 may be positioned on a sloping surface, such as a hillslope. In response to a motion control command, processor 302 may determine the X- Y- and Z-components of second position 602 based on the chassis angle position to account for the tilt angle of chassis 102 as well.

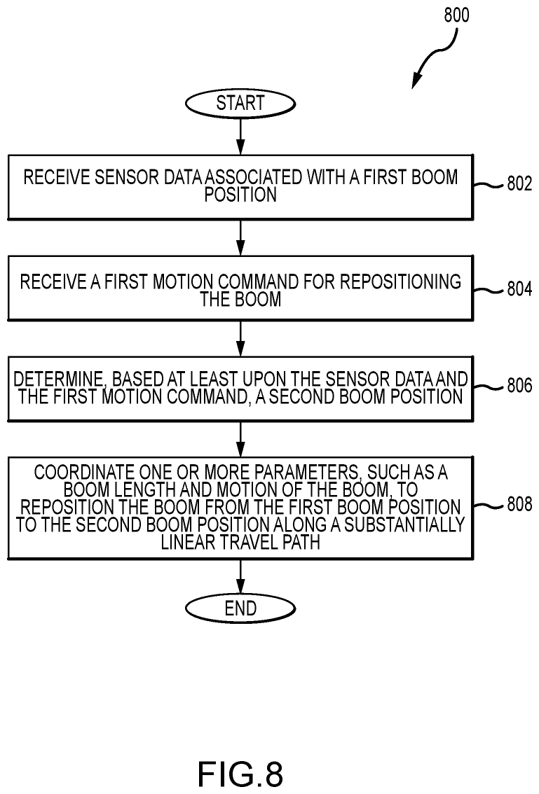

FIG. 8 is a flowchart illustrating an example process 800 for coordinating motion of boom 118 in response to a motion command. In the exemplary embodiment, and as described in greater detail above, processor 302 may perform operations including, but not limited to, receiving, from at least one sensor device 138-143, sensor data associated with a first position of boom 118, such as first position 402 and/or first position 602 (step 802). In addition, processor 302 may perform operations including receiving, from input device 114, a first motion command for repositioning boom 118 (step 804), and determining, based at least on the sensor data and the first motion command, a second position, such as second position 502 and/or second position 702, of boom 118 (step 806). In the exemplary embodiment, processor 302 may, in addition, perform operations that include coordinating a boom length and a motion of the boom to selectively reposition the boom from the first position (e.g., one or both of first positions 402 and/or 602) to the second position (e.g., one or both of second positions 502 and/or 702) along a substantially linear path, such as a substantially vertical path and/or a substantially horizontal path (step 808).

A construction machine and a control system for controlling motion of a boom thereof are thus described. In the exemplary embodiments, motion control of the boom may be greatly simplified, particularly for use by an operator. For example, the systems and methods described herein may facilitate coordinated motion of one or more physical parameters of the boom, such as a length of the boom, an elevation of the boom, and/or a position of the boom, to smoothly adjust for the tendency of the boom to follow an arcuate travel path in the absence of the coordinated motion controls. More particularly, the systems and methods described herein facilitate motion of the boom in one or more degrees of motion to maintain or establish a substantially linear (e.g., vertical and/or horizontal) travel path between starting and ending positions.

For example, and to illustrate, the systems and methods described herein can facilitate selective repositioning of a boom, which may include a material handling implement coupled to an end thereof, to ensure that a heavy load supported by the material handling implement is translated or repositioned in a Cartesian coordinate system without substantial arcuate motion of the load during transition between points in space. This can be achieved, as described herein, by moving the boom, and thus the load, in the Cartesian coordinate system in a substantially linear and/or rectilinear path of travel, such as vertically horizontally, between a X, Y, and/or Z coordinates, as desired. In the instance that the load is not repositioned in such a manner (e.g., when the load is repositioned in an arcuate path of travel, as described above), the load may, in some circumstances, swing or rock, which may, in some cases, work to destabilize the construction machine and/or result in a load that may inadvertently contact the construction machine as it swings or rocks.

Further, the features described herein permit repositioning the load supported by the material handling implement of the boom in a more intuitive manner. Specifically, an operator of the construction machine may move a control mechanism, such as a joystick, left and right to accomplish left and right (e.g., horizontal) motion of the boom, and up and down to accomplish up and down (e.g., vertical) motion of the boom. As a result, loads may be repositioned in space without the necessity of subsequently shortening or lengthening the boom to compensate for arcuate motion that occurs when an operator repositions the boom.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A construction machine comprising:
a boom; and
a control system comprising:
a memory device; and
a processor configured to execute instructions stored in the memory device, which when executed by the processor, cause the processor to perform operations comprising:
receiving at least a first motion command for repositioning the boom when the boom is deployed; and
in response to receiving the first motion command, repositioning the boom in one of i) a substantially vertical path between a first position and a second position, or ii) a substantially horizontal path between the first position and the second position.

2. The construction machine of claim 1, wherein the instructions, when executed, further cause the processor to perform operations comprising:
receiving, from at least a first sensor device, sensor data associated with the first position of the boom;
determining, in response to the first motion command, the second position of the boom, the second position different from the first position in at least two degrees of motion; and
in response to receiving the first motion command, coordinating a boom length and a motion of the boom to reposition the boom from the first position to the second position along a substantially linear path.

3. The construction machine of claim 1, wherein the instructions, when executed, further cause the processor to perform operations comprising coordinating boom length and a motion of the boom to reposition the boom along a substantially non-arcuate path between the first position and the second position.

4. The construction machine of claim 1, wherein the boom is capable of three degrees of motion, and wherein the instructions, when executed, further cause the processor to perform operations comprising repositioning the boom in a first degree of motion and a second degree of motion, while holding a third degree of motion constant.

5. The construction machine of claim 1, wherein the first motion command includes an instruction to move the boom in a Z-direction substantially parallel to a line of gravity of the boom, and wherein the instructions, when executed, further cause the processor to perform operations comprising:
determining a first X-coordinate, a first Y-coordinate, and a first Z-coordinate of the boom;
receiving, from at least a first sensor device, an extension position of the boom, the extension position including at least a first length of the boom;
receiving, from at least a second sensor device, an angle position of the boom, the angle position including an angle of the boom relative to a reference surface;
determining, in response to i) the first motion command, ii) the extension position of the boom, and iii) the angle position of the boom, a second Z-coordinate of the boom and a second length of the boom; and
in response to determining the second Z-coordinate of the boom and the second length of the boom, repositioning the boom from the first Z-coordinate to the second Z-coordinate along the substantially vertical path between the first Z-coordinate and the second Z-coordinate.

6. The construction machine of claim 5, wherein to reposition the boom, the instructions, when executed, further cause the processor to perform operations comprising:
one of extending or retracting the boom to the second length; and
one of raising or lowering the boom to the second Z-coordinate in coordination with extending or retracting the boom, whereby the boom is repositioned at the second Z-coordinate while at least one of the first X-coordinate and the first Y-coordinate are held substantially constant.

7. The construction machine of claim 5, wherein the instructions, when executed, further cause the processor to perform operations comprising:
receiving, from at least a third sensor device, a chassis angle position, the chassis angle position including an angle of a chassis of the construction machine relative to a reference surface;
further determining, in response to chassis angle position, the second Z-coordinate of the boom and the second length of the boom.

8. The construction machine of claim 1, wherein the first motion command includes an instruction to move the boom in one of an X-direction or a Y-direction, the X-direction and the Y-direction substantially normal to a line of gravity of the boom, and wherein the instructions, when executed, further cause the processor to perform operations comprising:
determining a first X-coordinate, a first Y-coordinate, and a first Z-coordinate of the boom;
receiving, from at least a first sensor device, an extension position of the boom, the extension position including at least a first length of the boom;
receiving, from at least a second sensor device, a first angle position of the boom, the angle position including an angle of the boom relative to a reference surface;
receiving, from at least a third sensor device, a chassis angle position, the chassis angle position including an angle of a chassis of the construction machine relative to the reference surface;
determining, in response to i) the first motion command, ii) the extension position of the boom, iii) the first angle position of the boom, and iv) the chassis angle position, at least one of a second X-coordinate or a second Y-coordinate of the boom and a second angle position of the boom; and
in response to determining at least one of the second X-coordinate or the second Y-coordinate and the second angle position of the boom, repositioning the boom along a substantially linear path.

9. The construction machine of claim 1, wherein the boom further comprises a jib coupled to and extending from the distal end of the boom, and wherein the instructions, when executed, further cause the processor to perform operations comprising one of extending or retracting the jib to reposition the boom.

10. A system for controlling a boom of a construction machine, the system comprising:
a processor; and
a memory device storing instructions, which when executed by the processor, cause the processor to perform operations comprising:
receiving, from an input device of the construction machine, an operator selection of one of i) a parabolic mode of operation, or ii) a rectilinear mode of operation;
in response to receiving the operator selection of the rectilinear mode of operation:
repositioning the boom from a first position to a second position, the second position different from the first position, along a substantially rectilinear path between the first position and the second position.

11. The system of claim 10, wherein the instructions, when executed, further cause the processor to perform operations comprising coordinating the boom length and the motion of the boom to reposition a distal end of the boom from the first position to the second position along at least one of i) a substantially vertical path, or ii) a substantially horizontal path.

12. The system of claim 10, wherein the instructions, when executed, further cause the processor to perform operations comprising coordinating a boom length and a motion of the boom to reposition a distal end of the boom along a substantially non-arcuate path between the first position and the second position.

13. The system of claim 10, wherein the boom is capable of three degrees of motion, and wherein the instructions, when executed, further cause the processor to perform operations comprising repositioning the boom in a first degree of motion and a second degree of motion, while holding a third degree of motion constant.

14. The system of claim 10, wherein the instructions, when executed, further cause the processor to perform operations comprising:
receiving a motion command from an operator of the construction machine;
determining a first X-coordinate, a first Y-coordinate, and a first Z-coordinate of the boom;
receiving, from at least a first sensor device, an extension position of the boom, the extension position including at least a first length of the boom;
receiving, from at least the a second sensor device, an angle position of the boom, the angle position including an angle of the boom relative to a reference surface;
determining, in response to i) the motion command, ii) the extension position of the boom, and iii) the angle position of the boom, a second Z-coordinate of the boom and a second length of the boom; and
in response to determining the second Z-coordinate of the boom and the second length of the boom, repositioning the boom from the first Z-coordinate to the second Z-coordinate along a substantially vertical path between the first Z-coordinate and the second Z-coordinate.

15. The system of claim 14, wherein to reposition the boom, the instructions, when executed, further cause the processor to perform operations comprising:
one of extending or retracting the boom to the second length; and
one of raising or lowering the boom to the second Z-coordinate in coordination with extending or retracting the boom, whereby the boom is repositioned at the second Z-coordinate while at least one of the first X-coordinate and the first Y-coordinate are held substantially constant.

16. The system of claim 14, further comprising at least a third sensor device, wherein the instructions, when executed, further cause the processor to perform operations comprising:
receiving, from at least the third sensor device, a chassis angle position, the chassis angle position including an angle of a chassis of the construction machine relative to a reference surface; and
further determining, in response to chassis angle position, the second Z-coordinate of the boom and the second length of the boom.

17. A system for controlling a boom of a construction machine, the system comprising:
a processor; and
a memory device storing instructions, which when executed by the processor, cause the processor to perform operations comprising:
receiving, from an input device of the construction machine, an operator selection of one of i) a parabolic mode of operation, or ii) a non-parabolic mode of operation;
in response to receiving the operator selection of the non-parabolic mode of operation:
repositioning the boom from a first position to a second position, the second position different from the first position in at least two degrees of motion within a Cartesian coordinate system.

18. The system of claim 17, wherein the instructions, when executed, further cause the processor to perform operations comprising coordinating the boom length and the motion of the boom to reposition a distal end of the boom from the first position to the second position along at least one of i) a substantially vertical path, or ii) a substantially horizontal path.

19. The system of claim 17, wherein the instructions, when executed, further cause the processor to perform operations comprising coordinating a boom length and a motion of the boom to reposition the boom along a substantially non-arcuate path between the first position and the second position.

20. The system of claim 17, wherein the boom is capable of three degrees of motion, and wherein the instructions, when executed, further cause the processor to perform operations comprising repositioning the boom in a first degree of motion and a second degree of motion, while holding a third degree of motion constant.
